(19) United States
(12) Patent Application Publication
(10) Pub. No.: US 2021/0409998 A1
(43) Pub. Date: Dec. 30, 2021

(54) QUALITY OF EXPERIENCE FLOW CONTROL FOR DUAL CONNECTIVITY

(71) Applicant: T-Mobile USA, Inc., Bellevue, WA (US)

(72) Inventors: Ming Shan Kwok, Seattle, WA (US); Alejandro Aguirre-Rivadeneyra, Sammamish, WA (US); Hsin-Fu Henry Chiang, Bellevue, WA (US); Wafik Abdel Shahid, Kenmore, WA (US)

(73) Assignee: T-Mobile USA, Inc.

(21) Appl. No.: 16/914,198

(22) Filed: Jun. 26, 2020

(51) Int. Cl. H04W 28/02; H04W 40/12

(52) U.S. Cl. CPC H04W 28/0268; H04W 88/08; H04W 40/12

(57) ABSTRACT

A flow controller executing at a network element of a telecommunication network can use packet characteristics of a data packet to select, from a set of QoE goals, a QoE goal for the data packet. The set of QoE goals can include prioritizing throughput, prioritizing lower latency, prioritizing reliability, and/or other QoE goals. The flow controller can also determine a routing scheme associated with the selected QoE goal, and cause the data packet to be routed to a user equipment via an LTE connection and/or a 5G connection according to the routing scheme.

### BACKGROUND

Dual connectivity arrangements can allow a user equipment (UE), such as a mobile phone, to wirelessly connect to different base stations of a telecommunication network simultaneously. In some cases, the base stations can use different radio access technologies. For example, a UE can connect to one base station using a Long-Term Evolution (LTE) connection, and also connect to another base station using a fifth generation New Radio (5G NR) connection. This type of dual connection can be referred to as an E-UTRAN New Radio-Dual Connectivity (EN-DC) connection.

When the UE has an EN-DC connection, or other type of dual connection, with two base stations, data packets in transit between a core network and the UE can be routed via either, or both, base stations. For example, a split bearer can be established that includes an LTE leg associated with the LTE connection, and a 5G leg associated with the 5G connection. Data packets can accordingly be routed over the 5G leg, the LTE leg, or both the 5G leg and the LTE leg.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example network environment in which a LTE can connect to a telecommunication network.

FIG. 2 shows an example table of packet characteristics, Quality of Experience (QoE) goals, and routing schemes that can be used by a flow controller.

FIG. 3A shows a first example in which a bearer passes from a core network to an eNB.

FIG. 3B shows a second example in which a bearer passes from a core network to a gNB.

FIG. 4 shows an example of data packets passing through protocol layers in an eNB and a gNB.

FIG. 5 shows an example network environment in which a flow controller can be executed outside a base station.

FIG. 6 shows an example system architecture for a network element configured to execute a flow controller.

FIG. 7 shows a flowchart of an example method of routing a data packet with a flow controller based on a QoE goal.

### DETAILED DESCRIPTION

### Introduction

Multiple radio access technology (RAT) Dual Connectivity (MR-DC) techniques have been developed that allow a UE to simultaneously use multiple types of radio access technologies to connect to a telecommunication network. For example, a radio access network (RAN) of the telecommunication network can include one or more base stations that use LTE radio access technologies, such as LTE evolved Node Bs (eNBs). The RAN of the telecommunication network can also include one or more base stations that use 5G NR radio access technologies, such as 5G gNBs. A UE that supports both LTE and 5G NR can use an E-UTRANl New Radio-Dual Connectivity (EN-DC) connection to wirelessly connect to both an LTE eNB and a 5G gNB. The UE can then send and/or receive data via one or both of the LTE connection and the 5G connection.

In some examples, when a UE is connected to both an eNB and a gNB, a split bearer can be established between a core network and the UE through both the eNB and the gNB. For example, user data can flow via a bearer from the core network to one of the eNB and the gNB, where the bearer can split into an LTE leg associated with the eNB and a 5G leg associated with the gNB. In some examples, a base station or other network element can use downlink Packet Data Convergence Protocol (PDCP) aggregation to aggregate data packets into a first group for a first leg of a split bearer and a second group for a second leg of the split bearer.

Many conventional dual connectivity arrangements prioritize routing data packets through only one of the two base stations, unless that base station cannot timely deliver the data packets to the UE. For example, one of the two base stations may be designated as a primary base station through which data packets for the UE are routed by default. However, if a buffer at the primary base station overflows, the primary base station can begin routing data packets that do not fit in the buffer to a secondary base station. The secondary base station can then forward those data packets on to the UE, while the primary base station forwards packets from its buffer to the UE.

Accordingly, in some conventional arrangements, dual connectivity and/or PDCP aggregation may be used as a backup solution during buffer overruns or other situations in which a primary base station is unable to process all of the data packets for a UE. For example, some previous solutions use a static algorithm in the primary base station that defaults to routing each new data packet through the primary base station unless a buffer of the primary base station is full, or is close to full. Accordingly, individual data packets are only sent via the secondary base station in such previous solutions if the primary base station's buffer is full or is close to full. Although such previous solutions may help deliver data packets to a UE that would have otherwise been delayed or even dropped due to a buffer overflow at a base station, such previous solutions may also be an inefficient use of resources. For example, if data packets are only sent to a UE via a primary base station, the secondary base station may be substantially idle with respect to the UE and available resources associated with the secondary base station may be wasted.

Many conventional dual connectivity solutions also use static routing algorithms based on buffer fullness levels or other resources associated with one or both of the base stations, but do not consider characteristics of individual data packets. Data packets routed to and from a UE may be associated with different types of applications and/or services. For example, data packets may be associated with streaming video services, real-time gaming sessions, voice calls, file downloads, web browsing sessions, or other types of applications and/or services. A user's perception of a Quality of Experience (QoE) related to such applications and/or services may differ depending on the type of application or service. For example, a user may perceive a low QoE if data packets for a real-time gaming session are delayed long enough that the real-time nature of the gaming session is disrupted, but may be less likely to perceive a low QoE if data packets for a static web page are similarly delayed. As another example, a user may perceive a high QoE if data packets associated with a download of a large file are delivered at a high throughput level, but perceive a lower QoE if the same data packets for the download are delivered over a low latency connection but at a lower throughput level.

However, many previous conventional dual connectivity routing solutions route data packets without considering the QoE provided to users with respect to different types of data packets. For example, static routing algorithms used in many previous solutions may treat data packets for delay-sensitive real-time gaming applications and for delay-tolerant web browsing sessions equally, and route both types of data packets through an LTE eNB by default unless the eNB's buffer is overflowing. However, in such situations, the user's QoE might have been improved if the delay-sensitive real-time gaming data packets had instead been routed over a 5G connection that has a lower latency than the default LTE connection.

The systems and methods described herein can be used to determine whether to route individual data packets to a UE over an LTE connection and/or a 5G connection, based on which connections are most likely to achieve QoE goals associated with the individual data packets. The QoE goals may include prioritizing throughput, prioritizing lower latency, prioritizing reliability, a default best effort QoE goal, custom QoE goals associated with particular applications or types of applications, and/or other QoE goals.

### Example Environment

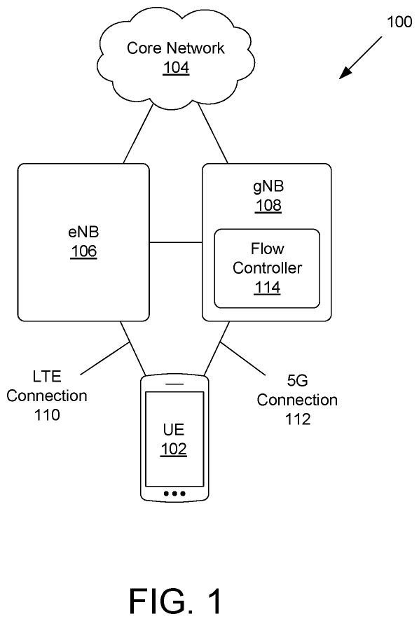

FIG. 1 shows an example network environment 100 in which a UE 102 can connect to a telecommunication network to engage in communication sessions for voice calls, video calls, messaging, data transfers, and/or any other type of communication. The UE 102 can be any device that can wirelessly connect to the telecommunication network. In some examples, the UE 102 can be a mobile phone, such as a smart phone or other cellular phone. In other examples, the UE 102 can be a personal digital assistant (PDA), a media player, a tablet computer, a gaming device, a smart watch, a hotspot, a personal computer (PC) such as a laptop, desktop, or workstation, or any other type of computing or communication device.

The telecommunication network can have one or more access networks that include base stations and/or other access points, as well as a core network 104 linked to the access networks. The access networks and/or the core network 104 can be compatible with one or more radio access technologies, wireless access technologies, protocols, and/or standards, such as 5G NR technology, LTE/LTE Advanced technology, other fourth generation (4G) technology, High-Speed Data Packet Access (HSDPA)/Evolved High-Speed Packet Access (HSPA+) technology, Universal Mobile Telecommunications System (UMTS) technology, Code Division Multiple Access (CDMA) technology, Global System for Mobile Communications (GSM) technology, WiMax® technology, WiFi® technology, and/or any other previous or future generation of radio access technology.

The UE 102 can wirelessly connect to one or more base stations or other access points of the access networks, and in turn be connected to the core network 104 via the base stations or other access points. In some examples, the core network 104 can be a packet core network of an LTE network, which may be referred to as an Evolved Packet Core (EPC). In other examples, the core network 104 can be a 5G core network.

The access networks can include an LTE access network known as an Evolved UMTS Terrestrial Radio Access Network (E-UTRAN). Base stations of the LTE access network can be known as eNBs, such as the eNB 106 shown in FIG. 1. The access networks can also include 5G access networks with base stations known as gNBs, such as the gNB 108 shown in FIG. 1. In some examples, the eNB 106 and the gNB 108 may be located at the same cell site. In other examples, the eNB 106 and the gNB 108 may be located at different cell sites.

One or both of the eNB 106 and the gNB 108 can be connected to the core network 104. For example, one or both of the eNB 106 and the gNB 108 may be connected to the core network 104 via S1 interfaces, or other interfaces, for transmission of user plane data and/or control plane data. The eNB 106 and the gNB 108 may also be connected to each other over an X2 interface, or other interface, for transmission of user plane data and/or control plane data.

The UE 102 and the telecommunication network can be configured to support dual connectivity between the UE 102 and multiple base stations in the access network. For example, the UE 102 can establish an LTE connection 110 with the eNB 106 and a 5G connection 112 with the gNB 108. The UE 102 can thus establish an EN-DC connection with the telecommunication network that uses both the LTE connection 110 and the 5G connection 112. An EN-DC connection that uses both the LTE connection 110 and the 5G connection 112 may be based on a 3GPP EN-DC configuration, such as an “option 3x” EN-DC configuration, “option 3” EN-DC configuration, “option 3a” EN-DC configuration, or other EN-DC configuration.

In some of these examples, the eNB 106 can be a master node in the EN-DC configuration, while the gNB 108 can be a secondary node. In other examples, the gNB 108 can be the master node and the eNB 106 can be the secondary node. The master node may be configured to exchange control plane data with the core network 104, the UE 102, and with the secondary node. In some examples, the secondary node may not have direct interfaces for exchanging control plane data with the core network 104 and/or the UE 102, but may send and receive control plane data via the master node. In some examples, both the eNB 106 and the gNB 108 may be configured to directly exchange user plane data with the core network 104. In other examples, one of the eNB 106 and the gNB 108 may instead indirectly exchange user plane data with the core network 104 via the other one of the eNB 106 and the gNB 108.

The LTE connection 110 and the 5G connection 112 may both be routes by which data packets can be exchanged between the core network 104 and the UE 102. However, metrics, such as throughput, packet delay (latency), delay variance, and/or other metrics, associated with the LTE connection 110 and the 5G connection 112 may vary. For instance, in some situations the 5G connection 112 may be associated with a higher throughput and/or a lower latency than the LTE connection 110.

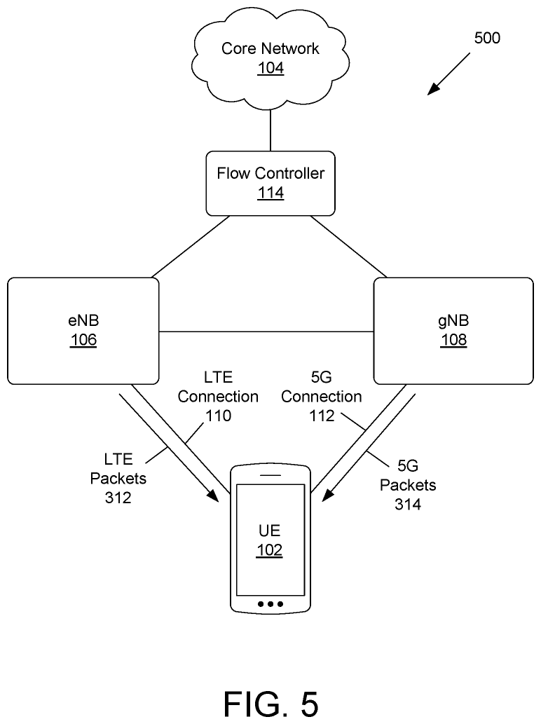

As described herein, a flow controller 114 can determine whether to route data packets to the UE 102 via the LTE connection 110, the 5G connection 112, or both the LTE connection 110 and the 5G connection 112. In some examples the flow controller 114 can be executed by the gNB 108, as shown in FIG. 1. However, in other examples the flow controller 114 may be executed by the eNB 106. In still other examples, the flow controller 114 can be executed by a different network element as discussed below with respect to FIG. 5, such as at an intermediate network element positioned between the core network 104 and the eNB 106 and/or gNB 108 that processes and/or routes data packets between the core network 104 and the eNB 106 and/or gNB 108.

The flow controller 114 can be configured to determine a QoE goal for a data packet, based on attributes of the data packet. The QoE goal can be to prioritize throughput, prioritize lower latency, prioritize reliability, a default best effort QoE goal, and/or any other goal. The flow controller 114 can also be configured to determine whether the LTE connection 110, the 5G connection 112, or a combination of both the LTE connection 110 and the 5G connection 112 is most likely to achieve the QoE goal for the data packet. The flow controller 114 can accordingly select the one or more connections most likely to achieve the QoE goal, and cause the data packet to be routed over the selected one or more connections.

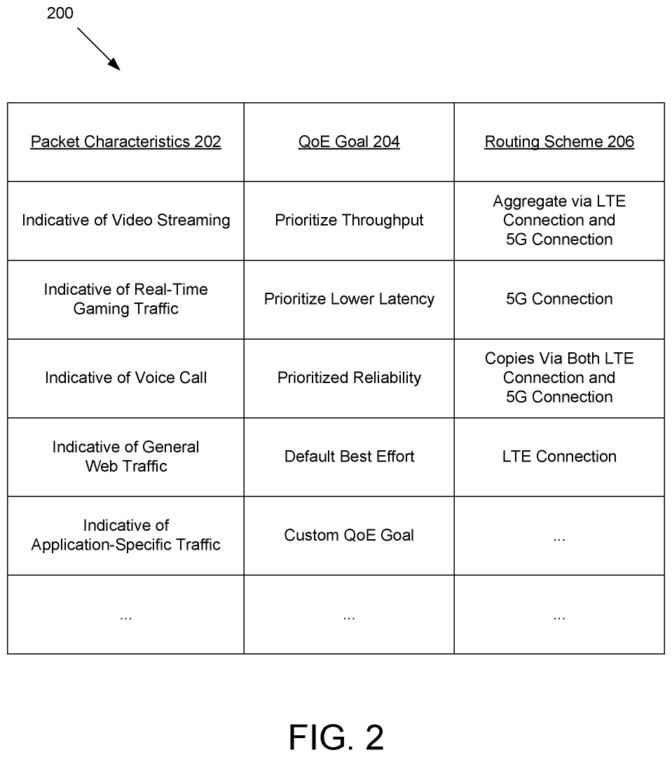

FIG. 2 shows an example table 200 of packet characteristics 202, QoE goals 204, and routing schemes 206. In some examples, the flow controller 114 can determine packet characteristics 202 of a data packet, and use the table 200 to determine QoE goals 204 and/or routing schemes 206 that correspond to the packet characteristics 202. The flow controller 114 can accordingly route the data packet via one or both of the LTE connection 110 or the 5G connection 112, based on the routing scheme 206 associated with the packet characteristics 202. In other examples, the flow controller 114 can use any other mapping data, set of rules, algorithm, or other method to identify a QoE goal 204 and/or a routing scheme 206 based on packet characteristics 202 of a data packet.

Packet characteristics 202 can be attributes of the data packet that can indicate a traffic type of the data packet, an application or application type associated with the data packet, a service or service type associated with the data packet, or any other information about the data packets.

In some examples, packet characteristics 202 can include a Differentiated Services Code Point (DSCP) marking associated with the data packet. A DSCP marking can be a header value, such as a field in an Internet Protocol (IP) header, that indicates whether the data packet is a best effort packet, a high priority packet, or other type or class of packet. For example, a data packet for a real-time voice call can have a DSCP marking indicating that the data packet is a high priority packet, while another data packet for a web browsing session can have a different DSCP marking indicating that the data packet is a best effort packet. In some examples, different DSCP values can be provided that uniquely identify data packets as being telephony packets, real-time interactive packets, multimedia streaming packets, high-throughput data packets, low-priority data packets, and/or other types or classes of data packets.

In some examples, packet characteristics 202 can include Quality of Service (QoS) Class Indicator (QCI) value associated with the data packet. For example, the QCI value may indicate a priority level associated with the data packet, whether the data packet is targeted for transmission at a guaranteed bit rate (GBR) or at a non-GBR, a packet delay budget associated with the data packet, and/or a packet error loss rate associated with the data packet. In some examples, QCI values 1 through 4 can be associated with GBR traffic, with QCI value 1 signifying conversational voice traffic, QoS value 2 signifying conversational video (live streaming) traffic, QoS value 3 signifying traffic such as real-time gaming traffic, and QoS value 4 signifying non-conversational video (buffered streaming). Additionally, in some examples, QCI values 5 through 9 can be associated with non-GBR best-effort traffic, with QCI value 5 signifying IP Multimedia Subsystem (IMS) signaling, QCI values 6, 8, and 9 signifying buffered streaming video and TCP-based file transfers, and QCI value 7 signifying non-GBR voice, live streaming video, and interactive gaming. In some examples, the flow controller 114 can determine the QCI value associated with the data packet based on the QCI value of a bearer that has been established to transport the data packet. In other examples, the flow controller 114 can determine a QCI value associated with the data packet based on header information or other data encoded in the data packet.

In some examples, packet characteristics 202 may also, or alternately be indicated in a Service Data Adaptation Protocol (SDAP) header of the data packet. For example, in 5G communications, an SDAP layer at an element of the core network 104 or in the gNB 108 may have added an SDAP header data to a data packet that contains QoS information about the data packet, such as a QoS flow identifier used to identify data packets associated with the same QoS flow. The QoS flow identifier can indicate a QoS value associated with the data packet, which may map to a particular QoE goal 204 as described herein. In some examples, other types of data may be included in an SDAP header, such as a type of service identifier or other data that may map to a QoE goal 204.

In some examples, packet characteristics 202 can also, or alternately, include other header information, such as source IP address, optional header field, or other data. For example, an optional header field may include information that identifies an application name or application type associated with the data packet. It still other examples, packet characteristics 202 can include data encoded into the body of the data packet that can be indicative of a traffic type or application associated with the data packet.

Overall, the flow controller 114 can perform packet inspection operations on a received data packet to determine packet characteristics 202 associated with the data packet. As noted above, the packet characteristics 202, such as a DSCP marking, QCI value, QoS flow identifier, and/or other data may be indicative of a traffic type, application, application type, service, service type, and/or other attributes of the data packet. The traffic type, application, application type, service, service type, and/or other attributes of the data packet 410 can correspond with a QoE goal 204, as shown in FIG. 2. Accordingly, the flow controller 114 can use the packet characteristics 202 of the data packet to determine the QoE goal 204 that maps to the packet characteristics 202.

QoE goals 204 may include prioritizing throughput, prioritizing lower latency, prioritizing reliability, a default best effort QoE goal 204, and/or other goals. In some examples, prioritizing throughput may be the QoE goal 204 for data packets with packet characteristics 202 indicating that the data packets are part of a buffered video streaming session, a file transfer, or other types of applications and/or services for which a user's QoE improves when data is transferred at higher throughput levels. For example, the user is likely to be more satisfied with a file transfer when the file transfer can be completed more quickly using higher throughput levels.

in some examples, prioritizing lower latency may be the QoE goal 204 for data packets with packet characteristics 202 indicating that the data packets are part of a real-time gaming session or other type of delay-sensitive session for which delayed delivery of the data packets may be likely to lead to a decrease in a user's QoE. For example, a user may have a decreased QoE when data packets for a real-time gaming session are delayed, and the real-time nature of the gaming session is disrupted. Accordingly, the user's QoE can be improved when lower-latency connections are prioritized for such data packets and the data packets can be delivered more quickly. Examples of a flow controller 114 routing data packets over an LTE connection 110 or a 5G connection 112 based on latencies associated with the connections are described in U.S. patent application Ser. No. 16/442,314, entitled “Dual Connectivity Flow Control” and filed on Jun. 14, 2019, which is hereby incorporated by reference.

In some examples, prioritizing reliability may be the QoE goal 204 for data packets with packet characteristics 202 indicating that the data packets are part of voice call, video call, or other real-time communication session. For example, a user's QoE may decrease when a voice call cuts out for a moment and the user cannot hear the other party. Accordingly, the user's QoE can be improved when data packets for voice calls can be delivered more reliably and the call experience is smoother.

In some examples, the packet characteristics 202 may correspond with a default best effort QoE goal 204. For example, the packet characteristics 202 may indicate that a data packet is associated with loading a web page, or other general internet traffic for which delivery delays may be less noticeable to users than other types of traffic. For instance, a user may be unlikely to notice when a web page takes an extra half second to load, and thus not perceive a decrease to the user's QoE. Accordingly, in this example, the QoE goal 204 can be to deliver the data packets at a default best effort level without specifically prioritizing throughput, lower latency, or reliability.

Each QoE goal 204 can correspond with a routing scheme 206. Routing schemes 206 may indicate that data packets should be routed over the LTE connection 110 only, over the 5G connection 112 only, or over both the LTE connection 110 and the 5G connection 112.

In some examples, QoE goals 204 can be mapped to corresponding routing schemes 206 that have been predetermined as being most likely to achieve the QoE goals 204. For example, in some situations the 5G connection 112 can be assumed to have a lower latency than the LTE connection 110, such as if the 5G connection 112 uses a millimeter wave (mmW) frequency band that generally provides lower latency data transmissions than LTE frequency bands. Accordingly, in some examples, when the flow controller 114 determines that data packets are associated with the QoE goal 204 of prioritizing lower latency, the corresponding routing scheme 206 can be to route the data packets over the 5G connection.

As another example, in some situations the 5G connection 112 can be assumed to have a higher throughput than the LTE connection 110. Accordingly, when the QoE goal 204 for data packets is to prioritize throughput, the flow controller 114 may select a routing scheme 206 that routes the data packets over the 5G connection 112. In other examples, the when the QoE goal 204 for data packets is to prioritize throughput, the flow controller 114 may select a routing scheme 206 that routes some of the data packets over the LTE connection 110 and other data packets over the 5G connection 112, thereby aggregating the connections to achieve higher throughput overall.

In other examples, the flow controller 114 may receive UE telemetry data from the UE 102, such as measurement reports of current radio conditions, measured signal strengths, measured latency values, measured throughput values, and/or other telemetry data. The UE telemetry can be associated with one or both of the LTE connection 110 and the 5G connection 112. The flow controller 114 may also, or alternately, itself measure UE telemetry data, and/or receive UE telemetry data from other network elements. As an example, U.S. patent application Ser. No. 16/442,314, incorporated herein by reference, describes examples of a flow controller 114 measuring latencies associated with an LTE connection 110 and a 5G connection 112 to determine which connection has the lower latency.

In some examples, the flow controller 114 may use UE telemetry data to determine which of the LTE connection 110 and the 5G connection may be more likely to deliver data packets at higher throughput levels and/or with lower latency. For instance, if radio conditions or signal strengths reported by the UE 102 indicate that the UE 102 has a solid LTE connection 110 but a weaker 5G connection 112, the flow controller 114 may determine that routing data packets via the LTE connection 110 is more likely to achieve a higher throughput and/or a lower latency. Accordingly, if the flow controller 114 determines that a QoE goal 204 for a data packet is to prioritize throughput or to prioritize lower latency, the flow controller 114 may use UE telemetry data to instead select a routing scheme 206 that routes the data packet over the LTE connection 110 instead of the 5G connection 112, as the UE telemetry indicates that the LTE connection 110 may have a better chance of achieving the QoE goal 204 in this situation than the 5G connection 112.

If the QoE goal 204 for a data packet is to prioritize reliability, in some examples the flow controller 114 can be configured to select a routing scheme 206 that sends copies of the same data packet over both the LTE connection 110 and the 5G connection 112. In this situation, sending a first copy of the data packet over the LTE connection 110 and sending a second copy of the data packet over the 5G connection 112 can improve the chances that at least one of the first copy and the second copy is received by the UE 102. This can be beneficial for a voice call, or other type of real-time communication session, for which a packet drop or other transmission errors can negatively impact a user's QoE. If a copy of a data packet is dropped by one of the connections, the other copy of the data packet may still be delivered over the other connection and the packet drop can be mitigated without impacting the user's QoE.

In some examples, if the QoE goal 204 for a data packet is the default best effort QoE goal, the flow controller 114 can be configured to route the data packet via the LTE connection 110 instead of the 5G connection 112. For example, in some cases general web traffic may be delivered to the UE over a higher-latency and/or lower-throughput LTE connection 110 without significantly impacting the QoE perceived by users. In other examples, if UE telemetry or other data indicates that the 5G connection 112 is currently higher-latency and/or lower-throughput with respect to the UE 102 than the LTE connection 110, the flow controller 114 may instead route data packets with the default best effort QoE goal via the 5G connection 112.

In some examples, packet characteristics 202, QoE goals 204, and/or routing schemes 206 can be defined for specific applications, and/or specific types of applications. For example, an application developer can provide specific or unique packet characteristics 202 that are indicative of data packets associated with that developer's application, and/or a specific QoE goal 204 for those data packets. For instance, an application developer can indicate that data packets for its application should have a QoE goal of prioritizing lower latency, or prioritizing throughput. The flow controller 114 can accordingly use the packet characteristics 202 provided by the application developer to identify data packets associated with the developer's application, and select a routing scheme 206 for those data packets that corresponds to the QoE goal 204 defined by the developer. In some examples, the application developer can use an Application Programming Interface (API) or other system exposed by a network operator or other entity that owns or manages the flow controller 114, such that the flow controller 114 can be configured according to the developer-provided information. In other examples, the network operator or other entity that owns or manages the flow controller 114 can work with application developers to configure the flow controller 114 to process data packets according to custom QoE goal 204, or otherwise develop custom QoE goals 204 for data packets of specific applications or specific types of applications.

The flow controller 114 may use one or more types of packet characteristic 202 to determine a corresponding QoE goal 204 and/or a routing scheme 206. For instance, in some examples the flow controller 114 may use QCI values to differentiate GBR and non-GBR data packets, and be configured to route GBR data packets over the 5G connection 112 and non-GBR data packets over the LTE connection 110. However, in other examples, the flow controller 114 may identify a set of non-GBR “best effort” data packets using QCI values or other packet characteristics 202, but select different routing schemes for different best effort data packets. For example, DSCP markings may indicate that some best effort data packets are for video streaming, and other best effort data packets are for real-time gaming. In this situation, although both types of data packets may be considered non-GBR best effort data packets, the flow controller 114 may determine that the QoE goal 204 for the video streaming packets is to prioritize throughput, and the QoE goal 204 for the real-time gaming packets is to prioritize lower latency. Accordingly, the flow controller 114 may select different routing schemes 206 for the best effort video streaming packets and the best effort real-time gaming packets based on the different QoE goals 204 associated with the best effort data packets.

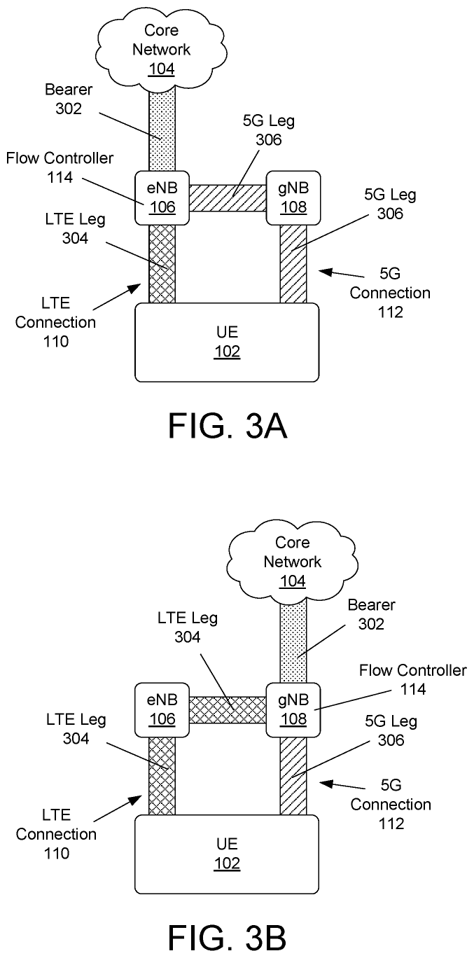

As another example, a set of data packets may arrive at the flow controller 114 via a bearer associated with a particular QCI value, such that all of the data packets are associated with that OCT value. However, a first subset of those data packets may have other packet characteristics 202 that correspond with a QoE goal 204 of prioritizing lower latency, and a second subset of those data packets may have other packet characteristics 202. that correspond with a QoE goal 204 of prioritizing throughput. Accordingly, even though both subsets are associated with the same bearer and/or QCI value, the flow controller 114 may select different routing schemes 206 for the two subsets based on the different QoE goals 204. In some examples, the bearer can be a split bearer, and the flow controller 114 can accordingly cause the subsets to be routed via different legs of the split bearer according to the selected routing schemes 206 as discussed below with respect to FIGS. 3A and 3B.

As another example, the flow controller 114 may determine from packet characteristics 202 that a data packet is associated with push-to-talk traffic for a first responder. For instance, the UE 102 to which the data packet is addressed may be associated with a user account for a first responder or emergency services provider. In some cases, push-to-talk data packets may be considered best effort data packets. However, the flow controller 114 may be configured to determine that the QoE goal 204 for push-to-talk data packets for first responders is to prioritize reliability. Accordingly, although the push-to-talk data packets may be considered best effort data packets, the flow controller 114 may select a routing scheme 206 that routes copies of the push-to-talk data packets over both the LTE connection 110 and the 5G connection 112 in order to increase the likelihood that at least one of the two copies arrives at the UE 102, thereby increasing reliability.

In some examples, the flow controller 114 may also use UE telemetry data to alter a set of data packets 410 being sent to the UE 102. For example, if UE telemetry data indicates that a user of the UE 102 is experiencing a low QoE due to latency associated with buffering of a 1080p video stream, and a device or subscriber profile indicates that a screen of UE 102 is not capable of displaying 1080p video, the flow controller 114 may cause a network element to reduce the bitrate of the video stream. In this situation, the reduction of the video bitrate may help improve the user's QoE, as data packets of the video stream can be delivered at the lower bitrate over one or more of the LTE connection 110 and the 5G connection 112 with less latency and the user may be unlikely to notice the decrease in video quality due to the hardware limitations of the screen of the UE 102. In other examples, the flow controller 114 may also attempt to improve the user's QoE, by routing data packets over unlicensed spectrum in addition to, or as an alternative to, the LTE connection 110 and/or the 5G connection 112. In still other examples, the flow controller 114 or other element of the telecommunication network may determine that a limitation of a subscriber data plan is impacting the user's QoE, and suggest changes to the subscriber data plan to permit data to be sent via the LTE connection 110 and/or the 5G connection 112 at higher throughput levels and/or lower latency levels to increase the user's QoE.

In some examples, the flow controller 114 can also use macro-level UE telemetry data associated with multiple UEs 102 connected to one or both of the eNB 106 and the gNB 108 to determine a QoE experienced by users of the multiple UEs 102, and take action to improve the QoE experienced by the users. For example, if UE telemetry data associated with multiple UEs 102 located in a particular geographic area indicate that users are experiencing a poor QoE, such as if the UEs are at a stadium or other location during an event and are all streaming multimedia data at the same time, the flow controller 114 or other element of the telecommunication network can aggregate the data packets of that streaming media data to a particular network slice in order to improve the users' QoE. In some examples, the flow controller 114 or other element of the telecommunication network can use one or more machine learning algorithms, such as convolutional neural networks, recurrent neural networks, other types of neural networks, nearest-neighbor algorithms, regression analysis, Gradient Boosted Machines (GBMs), Random Forest algorithms, deep learning algorithms, and/or other types of artificial intelligence or machine learning frameworks, to identify and/or aggregate homogenous network traffic to a particular network slice.

FIGS. 3A and 3B depict examples of bearers that can be established between the core network 104 and the UE 102 via the eNB 106 and the gNB 108. When the UE 102 connects to the telecommunication network, one or more bearers can be established between the core network 104 and the UE 102. Bearers can be virtual channels used to transport data for the UE 102 between network elements. For example, an E-UTRAN Radio Access Bearer (E-RAB) can be established between a gateway of the core network 104 and the UE 102, with the E-RAB including an S1 bearer between the gateway of the core network 104 and the eNB 106, and a data radio bearer between the eNB 106 and the UE 102. The LTE connection 110 can thus be associated with the data radio bearer between the eNB 106 and the UE 102. The 5G connection 112 can similarly be associated with a data radio bearer between the gNB 108 and the UE 102. Multiple bearers can be up between the network elements for different types of traffic for the UE 102. For example, the telecommunication network can set up a default bearer for general traffic associated with the UE 102, as well as dedicated bearers for traffic associated with specific services. For instance, a dedicated bearer can be set up for voice call data when the UE 102 is engaged in a voice call.

In some examples, a bearer between the core network 104 and the UE 102 can be established as a split bearer that passes through both the eNB 106 and the gNB 108 when an EN-DC connection has been established for the UE 102. The split bearer can include a bearer 302 that splits into an LTE leg 304 associated with the LTE connection 110 between the UE 102 and the eNB 106, and into a 5G leg 306 associated with the 5G connection 112 between the LTE 102 and the gNB 108. In some examples, the flow controller 114 can be executed at the base station at which the bearer 302 splits into the LTE leg 304 and the 5G leg 306. Accordingly, the flow controller 114 can route data packets over the LTE leg and/or the 5G leg 306 based on routing schemes 206 that correspond to QoE goals 204 associated with the data packets.

FIG. 3A shows a first example in which the bearer 302 passes from the core network 104 to the eNB 106. In this example, the bearer 302 splits into the LTE leg 304 and the 5G leg 306 at the eNB 106. The LTE leg 304 can pass directly from the eNB 106 to the UE 102 via the LTE connection 110. The 5G leg 306 can pass from the eNB 106 to the gNB 108, and then on to the UE 102 via the 5G connection 112. In this example, the flow controller 114 can be executed at the eNB 106 to control which data packets are routed to the UE 102 via the LTE leg 304 and/or the LTE connection 110, and which data packets are routed to the UE 102 via the 5G leg 306 and/or the 5G connection 112.

FIG. 3B shows a second example in which the bearer 302 passes from the core network 104 to the gNB 108. In this example, the bearer 302 splits into the LTE leg 304 and the 5G leg 306 at the gNB 108. The LTE leg 304 can pass from the gNB 108 to the eNB 106, and then on to the UE 102 via the LTE connection 110. The 5G leg 306 can pass directly from the gNB 108 to the UE 102 via the 5G connection 112. In this example, the flow controller 114 can be executed at the gNB 108 to control which data packets are routed to the UE 102 via the LTE leg 304 and/or the LTE connection 110, and which data packets are routed to the UE 102 via the 5G leg 306 and/or the 5G connection 112.

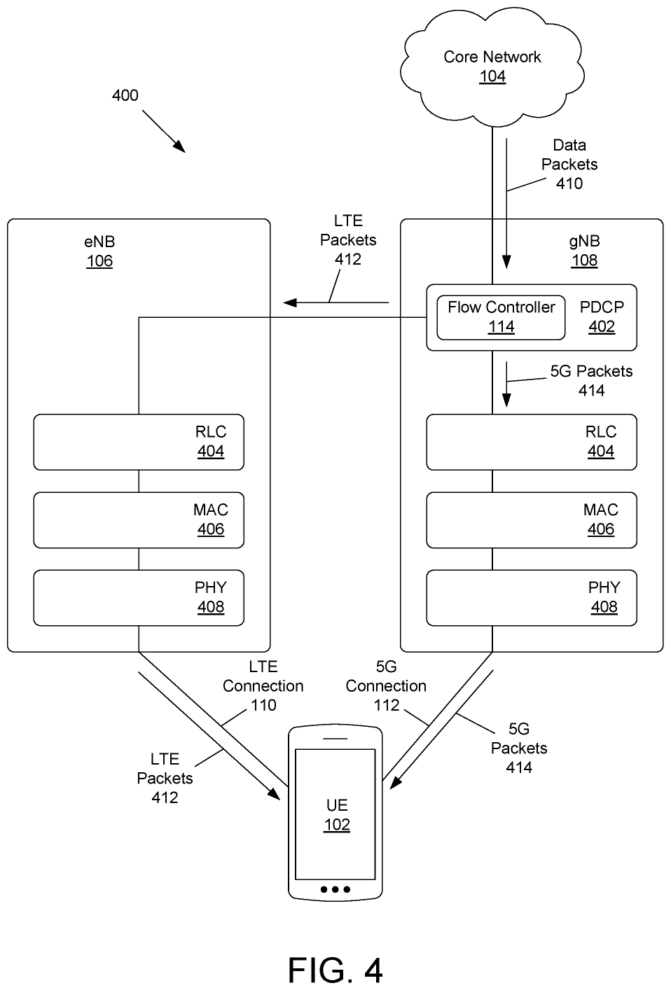

FIG. 4 shows an example of data packets 410 passing through protocol layers in the eNB 106 and the gNB 108. Downlink data can pass through multiple layers of a protocol stack in the eNB 106 and/or the gNB 108 before being transmitted to the UE 102. Each layer may process data received from a previous layer, for instance by adding its own header or performing any other operation on the data, and can then pass the data to the next layer. When a data packet 410 is received at the UE 102, corresponding layers at the UE 102 can reverse the operations performed by layers in the eNB 106 or the gNB 108 to find or reconstruct the data that was originally s by the core network 104. The layers in the protocol stack can include a Packet Data Convergence Protocol (PDCP) layer 402, a Radio Link Control (RLC) layer 404, a Media Access Control (MAC) layer 406, and/or a physical (PHY) layer 408. In some examples, a SDAP layer may be present above the PDCP layer 402. For instance, in some examples the gNB 108 may have an SDAP layer above the PDCP layer 402.

As shown in FIG. 4, the PDCP layer 402 of the gNB 108 can receive data packets 410, such as IP packets for user plane data, from the core network 104. In some examples, the PDCP layer 402 can receive the data packets 410 within service data units (SDUs) output by an upper SDAP layer. The PDCP layer 402 can operate on the data packets 410 and output protocol data units (PDUs) that include one or more portions the data packets 410 on to the next layer of the protocol stack, such as the RLC layer 404. For example, the PDCP layer 402 can perform one or more operations on data packets 410, such as adding a PDCP header or performing header compression, ciphering, and/or integrity protection, and output the data packets 410 as PDUs to the RLC layer 404.

The PDCP layer 402 at the gNB 108 can be where a split bearer divides into an LTE leg 304 and a 5G leg 306, or otherwise be where the gNB 108 can route data packets 410 over one or both of the LTE connection 110 and the 5G connection 112. The flow controller 114 described herein can execute on the gNB 108 at the PDCP layer 402 to group, aggregate, and/or divide data packets 410 received from the core network 104 into LTE packets 412 and 5G packets 414. In some examples, aggregation of data packets 410 at the PDCP layer 402 into LTE packets 412 and 5G packets 414 for different legs of a split bearer can be referred to as “downlink PDCP aggregation.”

The LTE packets 412 can be data packets 410 that the flow controller 114 determines have a QoE goal 204 associated with the LTE connection 110. For example, in some situations the LTE packets 412 may include general web traffic data packets 410, a subset of video streaming or file download data packets 410 (while another subset of such data packets 410 is sent as 5G packets 414 over the 5G connection 112 to increase throughput in the aggregate), or copies of voice call data packets 410 (while other copies of the same voice call data packets 410 are sent as 5G packets 414 to increase reliability). The flow controller 114 can route the LTE packets 412 via the LTE connection 110 and/or LTE leg 304. For example, the LTE packets 412 from the gNB 108 to the eNB 106 via an X2 interface or other interface. In some examples, because the LTE packets 412 have already been processed at the PDCP layer 402 of the gNB 108, the LTE packets 412 can be passed directly to the RLC layer 404 of the eNB 106. In other examples, the eNB 106 may pass the LTE packets 412 through a PDCP layer 402 of the eNB 106 to the RLC layer 404 of the eNB 106.

The 5G packets 414 can be data packets 410 that the flow controller 114 determines have a QoE goal 204 associated with the 5G connection 112. For example, in some situations the 5G packets 414 may include video streaming or file download data packets 410 (sent alone or in the aggregate with another set of data packets 410 sent as LTE packets 412), real-time gaming data packets 410, or copies of voice call data packets 410 (while other copies of the same voice call data packets 410 are sent as LTE packets 412 to increase reliability). The flow controller 114 can route the 5G packets 414 via the 5G connection 112 and/or 5G leg 306, for instance by passing the 5G packets 414 from the PDCP layer 402 to the RLC layer 404 within the gNB 108.

in some example, the flow controller 114 can cause copies of a data packet 410 to be sent as an LTE packet 412 via the eNB 106 and also as a 5G packet 414 via the gNB 108. For example, if the flow controller 114 determines that the QoE goal 204 for the data packet 410 is to prioritize reliability, as discussed above the flow controller 114 can forward a first copy of the data packet 410 as an LTE packet 412 via the eNB 106 and a second copy of the data packet 410 as a 5G packet 414 to thereby increase the chances that at least one of the LTE packet 412 and the 5G packet 414 successfully reaches the UE 102.

An RLC layer 404 at the eNB 106 can receive LTE packets 412 output by the PDCP layer 402 of the gNB 108, while a similar RLC layer 404 at the gNB 108 can receive 5G packets 414 output by the PDCP layer 402 of the gNB 108. The respective RLC layers 404 at the eNB 106 and the gNB 108 can perform operations on the received data, including error detection, segmentation, re-segmentation, or other operations. Each RLC layer 404 can pass its output to a MAC layer 406, which can perform other operations including error correction, scheduling, or prioritization. Each MAC layer 406 can similarly pass its output to a PHY layer 408. where the data can be transmitted to the UE 102 over an air interface associated with the LTE connection 110 or the 5G connection 112.

The RLC layer 404, the MAC layer 406, and/or the PRY layer 408 may each process or encapsulate data received from upper layers into its own output. However, the data sent by the PRY layer 408 of the eNB 106 can include the LTE packets 412 output by the PDCP layer 402 of the gNB 108. The data sent by the PHY layer 408 of the gNB 108 can similarly include the 5G packets 414 output by the PDCP layer 402 of the gNB 108. The UE 102 can accordingly process received data at a PRY layer 408 of the LTE 102, a MAC layer 406 of the LTE 102, and an RLC layer 404 of the UE 102 to find or reconstruct the LTE packets 412 and the 5G packets 414. The LTE 102 can also process the LTE packets 412 and the 5G packets 414 at a PDCP layer 402 of the UE 102 to reconstruct the data packets 410 originally sent by the core network 104.

Although FIG. 4 shows the flow controller 114 located at the PDCP layer 402 of the gNB 108, in other examples the flow controller 114 can be located at the PDCP layer 402 of the eNB 106. For instance, when the flow controller 114 is located at the PDCP layer 402 of the eNB 106, the flow controller 114 can similarly group, aggregate, and/or divide data packets 410 received from the core network 104 into LTE packets 412 and 5G packets 414 based on packet characteristics 202 of the data packets 410. The flow controller 114 at the PDCP layer 402 of the eNB 106 can route the LTE packets 412 to the RLC layer 404 within the eNB 106, and can route the 5G packets 414 to the gNB 108 via an X2 interface or other interface. Subsequent RLC layers 404, MAC layers 406, and layers 408 in the eNB 106 and the gNB 108 can then further operate on the LTE packets 412 and the 5G packets 414, as described above, before the LTE packets 412 and the 5G packets 414 are transmitted to the UE 102 via the LTE connection 110 and the 5G connection 112.

In other examples, the flow controller 114 can execute at another network element, outside a base station. For example, FIG. 5 shows an example network environment 500 in which the flow controller 114 can be executed at a network element positioned between the core network 104 and the eNB 106 and/or the gNB 108. The core network 104 can have software and/or hardware elements, such as gateways, routers, and other nodes, that can route data packets from the core network 104 to base stations such as the eNB 106 and the gNB 108. Such data packets may pass through one or more intermediate network elements, such as a base station hotel, a neural host location, a mobile switching office, or other network element. In some cases, such network elements can execute PDCP layer functions and/or other higher layer RAN functions instead of, or in addition to, base stations in the RAN 104. Accordingly, as shown in FIG. 5, in some examples the flow controller 114 can execute at a network element that processes and/or routes data packets between the core network 104 and the eNB 106 and/or gNB 108.

In these examples, the flow controller 114 between the base stations and the core network 104 can determine QoE goals 204 for data packets 410 based on packet characteristics 202, and select routing schemes 206 that correspond to the QoE goals 204, as discussed above with respect to FIG. 2. In some examples, if the flow controller 114 determines that a data packet 410 should be routed over the LTE connection 110 to the UE 102, the flow controller 114 may cause the network element to route the data packet 410 to the eNB 106, such that the eNB 106 can in turn forward the data packet 410 to the UE 102. Similarly, if the flow controller 114 determines that a data packet 410 should be routed over the 5G connection 112 to the UE 102, the flow controller 114 may cause the network element to route the data packet 410 to the gNB 108, such that the gNB 108 can in turn forward the data packet 410 to the LTE 102.

In other examples, the flow controller 114 may select a routing scheme 206 for a data packet 410 based on its packet characteristics 202, and can and modify or otherwise mark the data packet 410 with an identifier of the selected routing scheme 206. The network element can then transmit the data packet to the eNB 106 or the gNB 108, which can in turn route the data packet 410 over the LTE connection 110 and/or 5G connection 112 according to the identifier of the selected routing scheme 206 added by the flow controller 114 in the core network 104.

In some examples, one or more elements of the telecommunication network can execute a virtual RAN in which processing functions otherwise performed at the eNB 106 and/or the gNB 108 can be executed in virtual machines on servers or other centralized computing elements. In these examples, the flow controller 114 may be executed as part of a virtual RAN. The flow controller 114 in the virtual RAN can also determine QoE goals 204 for data packets 410 based on packet characteristics 202, and select routing schemes 206 that correspond to the QoE goals 204, as discussed above with respect to FIG. 2. The flow controller 114 in the virtual RAN can thus cause the data packets 410 to be routed to the UE 102 via one or both of an LTE connection 110 and a 5G connection, according to the selected routing schemes 206.

### Example Architecture

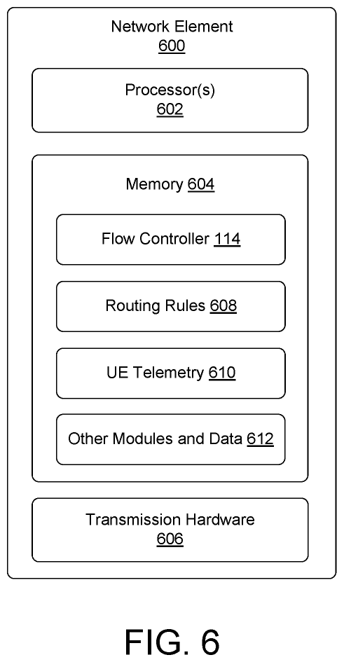

FIG. 6 shows an example system architecture for a network element 600 configured to execute the flow controller 114, in accordance with various examples. In various examples, the network element 600 can be the eNB 106, the gNB 108, a base station hotel, a neural host location, a mobile switching office, a server or other computing device that executes elements of a virtual RAN, or any other element of the telecommunication network that is configured to cause data packets 410 to be transmitted to the UE 102 over the LTE connection 110 or the 5G connection 112. As shown, the network element 600 can include processor(s) 602, memory 604, and transmission hardware 606. The memory 604 can store computer-readable instructions and/or other data associated with the flow controller 114, routing rules 608, UE telemetry 610, and other module and data 612.

In various examples, the processor(s) 602 can be a central processing unit (CPU), a graphics processing unit (GPU), both CPU and GPU, or any other type of processing unit. Each of the one or more processor(s) 602 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution

The processor(s) 602 may also be responsible for executing all computer applications stored in the memory 604, which can be associated with types of volatile (RAM) and/or nonvolatile (ROM) memory.

In various examples, memory 604 can include system memory, which may be volatile (such as RAM), non-volatile (such as ROM, flash memory, etc.) or some combination of the two. The memory 604 can also include additional data storage devices (removable and/or non-removable) such as, for example, magnetic disks, optical disks, or tape. Memory 604 can further include non-transitory computer-readable media, such as volatile and nonvolatile, removable and non-removable media implemented in any method or technology for storage of information, such as computer-readable instructions, data structures, program modules, or other data. For example, the memory 604 can store software or firmware elements, such as computer-readable instructions that are executable by the one or more processors 602. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the network element 600. Any such non-transitory computer-readable media may be part of the network element 600.

The transmission hardware 606 can include one or more modems, receivers, transmitters, antennas, error correction units, symbol coders and decoders, processors, chips, application specific integrated circuits (ASICs), programmable circuit (e.g., field programmable gate arrays), firmware components, and/or other components that can establish connections with one or more UEs 102, one or more base stations, and/or the core network 104, and transmit data over such connections. For example, when the network element 600 is a gNB 108, the transmission hardware 606 can establish the 5G connection 112 with the LTE 102 over an air interface, a connection with the eNB 106 over an X2 interface, and a connection with the core network 104 over an S1 interface. The transmission hardware 606 can also support transmissions using one or more radio access technologies, such as 5G NR or LTE, as discussed above.

As discussed above, the flow controller 114 can process data packets 410 by using packet characteristics 202 of the data packets 410 to determine QoE goals 204 associated with the data packets 410. The flow controller 114 can also cause the network element 600 to route individual data packets 410 over one or both of the LTE connection 110 and the 5G connection based on the QoE goals associated with the data packets 410.

In some examples, the flow controller 114 can use the routing rules 608 stored in the memory to determine the QoE goal 204 and/or a routing scheme 206 for individual data packets 410. In some examples the routing rules 608 can be a table, such as the table 200 shown in FIG. 2. In other examples, the routing rules 608 can be other mapping data that associates packet characteristics 202 with QoE goals 204 and/or routing schemes 206, a set of rules, an algorithm, or other data that the flow controller 114 can use to identify a QoE goal 204 and/or a routing scheme 206 based on packet characteristics 202 of a data packet 410.

In some examples, the memory 604 can store UE telemetry 610, such as measurements and reports associated with the UE 102 or connections with the UE 102. For example, the UE telemetry 610 can include such as measurement reports provided by the UE 102 of current radio conditions, measured signal strengths, measured latency values, measured throughput values, and/or other telemetry data. In other examples, the UE telemetry 610 can include measurements of latency, throughput, bandwidth, congestion levels, and/or other data associated with the LTE connection 110 and/or the 5G connection 112 measured by the network element 600 or provided by other network elements. For example, the network element 600 may measure or estimate a connection latency associated with the LTE connection 110 or the 5G connection 112 by measuring a round-trip time (RTT) between when data is sent to the UE 102. over that connection and when a response is received from the UE 102, and using the RTT as UE telemetry 610 associated with a latency metric.

The other modules and data 612 stored in the memory 604 can be utilized by the network element 600 to perform or enable performing any action taken by the network element 600. The modules and data 612 can include a platform, operating system, firmware, and/or applications, and data utilized by the platform, operating system, firmware, and/or applications.

### Example Operations

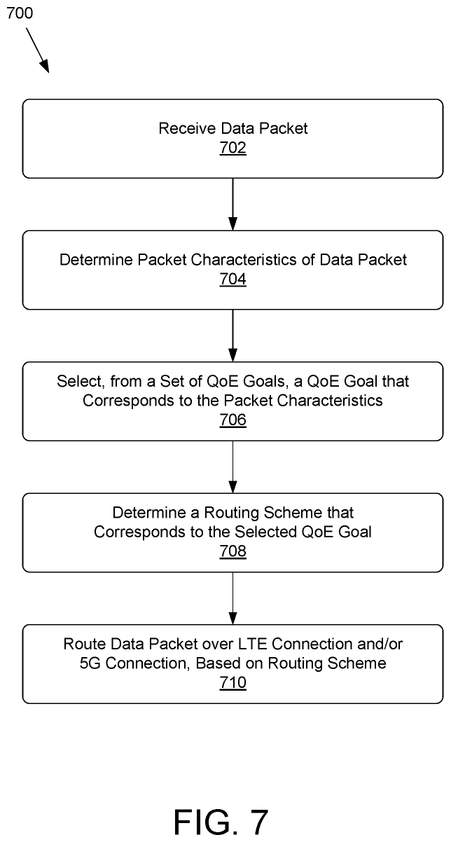

FIG. 7 shows a flowchart of an example method 700 of routing a data packet 410 with a flow controller 114 based on a QoE goal 204. In some examples, the flow controller 114 may execute at a gNB 108 as shown in FIG. 1. In other examples, the flow controller 114 may execute at an eNB 106. In still other examples, the flow controller 114 may execute outside a base station as shown in FIG. 5.

At block 702, the flow controller 114 may receive a data packet 410. In some examples, the flow controller 114 may execute at a PDCP layer of a gNB 108 or eNB 106, and can receive the data packet 410 from the core network 104 and/or via higher layers of a protocol stack in the gNB 108 or eNB 106. In other examples, such as when the flow controller 114 executes outside a base station at an intermediate network element, the flow controller 114 can receive the data packet 410 from the core network 104.

At block 704, the flow controller 114 can determine packet characteristics 202 of the data packet 410. The packet characteristics 202 can include a DSCP marking, QCI value, QoS flow identifier, one or more header values, information from the body of the data packet, and/or other information associated with the data packet 410.

At block 706, the flow controller 114 can select, from a set of QoE goals, a particular QoE goal that corresponds to the packet characteristics 202. The set of QoE goals 204 may include prioritizing throughput, prioritizing lower latency, prioritizing reliability, a default best effort QoE goal 204, custom QoE goals 204 associated with particular applications or types of applications, and/or other QoE goals 204. For example, the flow controller 114 can use a table 200 or other routing rules 608 to select, from the set of QoE goals 204, the QoE goal 204 that corresponds to the packet characteristics 202.

At block 708, the flow controller 114 can determine a routing scheme 206 that corresponds to the selected QoE goal 204. In some examples, the flow controller 114 can use a table 200 or other routing rules 608 to select a predetermined routing scheme 206 that corresponds to the selected QoE goal 204. For examples, the table 200 may indicate that when the QoE goal 204 is to prioritize lower latency, the predetermined routing scheme 206 for that QoE goal 204 is to route the data packet 410 via the 5G connection 112. However, in other example, the flow controller 114 can use LTE telemetry 610 and/or other measurements to determine which of the LTE connection 110 alone, the 5G connection 112 alone, or a combination of the LTE connection 110 and the 5G connection 112 together is expected to best achieve the selected QoE goal 204. For example, when the selected QoE goal 204 is to prioritize lower latency, the LTE telemetry 610 may indicate which of the LTE connection 110 and the 5G connection 112 currently has lower latency metrics, such that the flow controller 114 can route the data packet 410 via the lower-latency connection. As another example, when the selected QoE goal 204 is to prioritize throughput, the UE telemetry 610 may indicate which of the LTE connection 110 and the 5G connection 112 is currently associated with higher throughput levels to the UE 102, such that the flow controller 114 can route the data packet 410 via the higher-throughput connection.

At block 710, the flow controller 114 can route the data packet 410 to the UE 102 via the LTE connection 110 and/or the 5G connection 112, according to the selected routing scheme 206. For example, if the selected routing scheme 206 is the LTE connection 110 alone, the flow controller 114 can route the data packet 410 via the LTE connection 110. If the selected routing scheme 206 is the 5G connection 112 alone, the flow controller 114 can route the data packet 410 via the 5G connection 112. If the selected routing scheme 206 is to aggregate the LTE connection 110 and the 5G connection 112, the flow controller 114 can route the data packet 410 via one of the LTE connection 110 and the 5G connection 112, and route other data packets 410 in the same flow and/or that are associated with the same QoE goal or routing scheme over the other one LTE connection 110 and the 5G connection 112 in order to transmit data packets over both the LTE connection 110 and the 5G connection 112. If the selected routing scheme 206 is to send copies of the data packet 410 over both the LTE connection 110 and the 5G connection 112, the flow controller 114 can route a first copy of the data packet 410 via the LTE connection 110 and a second copy of the data packet 410 via the 5G connection 112.

Although the subject matter has been described in language specific to structural features and/or methodological acts, it is to be understood that the subject matter is not necessarily limited to the specific features or acts described above. Rather, the specific features and acts described above are disclosed as example embodiments.

1. A method, comprising:
receiving, by a flow controller executing at a network element of a telecommunication network, a data packet for a user equipment (UE);
determining, by the flow controller, one or more packet characteristics of the data packet;
selecting, by the flow controller from a set of Quality of Experience (QoE) goals, a QoE goal that corresponds to the one or more packet characteristics;
determining, by the flow controller and based at least in part on telemetry data received from the UE, a routing scheme that corresponds to the QoE goal; and
causing, by the flow controller, the data packet to be routed to the UE over at least one of a Long-Term Evolution (LTE) connection and a fifth generation (5G) connection based on the routing scheme.

2. The method of claim 1, wherein the LTE connection and the 5G connection are associated with legs of a split bearer.

3. The method of claim 1, wherein the network element at which the flow controller executes is a base station of the telecommunication network that is associated with one of the LTE connection or the 5G connection.

4. The method of claim 1, wherein the network element at which the flow controller executes is positioned between a core network of the telecommunication network and one or more base stations associated with the LTE connection or the 5G connection.

5. The method of claim 1, wherein the network element at which the flow controller executes is in a virtual radio access network.

6. The method of claim 1, wherein the flow controller executes at a Packet Data Convergence Protocol (PDCP) layer in the network element.

7. The method of claim 1, wherein the set of QoE goals includes two or more of:
prioritizing throughput;
prioritizing lower latency;
prioritizing reliability; and
a default best effort QoE goal.

8. The method of claim 7, wherein the flow controller selects the QoE goal of prioritizing throughput based on the one or more packet characteristics, and the routing scheme that corresponds to prioritizing throughput comprises routing the data packet at least via one of the 5G connection and the LTE connection that is associated with a higher throughput level.

9. The method of claim 7, wherein the flow controller selects the QoE goal of prioritizing lower latency based on the one or more packet characteristics, and the routing scheme that corresponds to prioritizing lower latency comprises routing the data packet via one of the 5G connection and the LTE connection that is associated with a lower latency level.

10. The method of claim 7, wherein the flow controller selects the QoE goal of prioritizing reliability based on the one or more packet characteristics, and the routing scheme that corresponds to prioritizing reliability comprises routing a first copy of the data packet via the 5G connection and routing a second copy of the data packet via the LTE connection.

11. The method of claim 7, wherein the flow controller selects the default best effort QoE goal based on the one or more packet characteristics, and the routing scheme that corresponds to the default best effort QoE goal comprises routing the data packet via the LTE connection.

12. The method of claim 7, wherein the set of QoE goals further includes a custom QoE goal for data packets associated with a particular application or particular type of application.

13. A network element, comprising:
one or more processors; and
memory storing computer-executable instructions that, when executed by the one or more processors, cause a flow controller of the network element to perform operations comprising:
receiving a data packet for a user equipment (UE);
determining one or more packet characteristics of the data packet;
selecting, from a set of Quality of Experience (QoE) goals, a QoE goal that corresponds to the one or more packet characteristics;
determining a routing scheme that corresponds to the QoE goal based at least in part on telemetry data received from the UE; and
causing the data packet to be routed to the UE over at least one of a Long-Term Evolution (LTE) connection and a fifth generation (5G) connection based on the routing scheme.

14. The network element of claim 13, wherein the network element is a base station of a telecommunication network that is associated with one of the LTE connection or the 5G connection.

15. The network element of claim 13, wherein the network element is positioned between a core network of a telecommunication network and one or more base stations associated with the LTE connection or the 5G connection.

16. The network element of claim 13, wherein the set of QoE goals includes two or more of:
prioritizing throughput;
prioritizing lower latency; and
prioritizing reliability.

17. One or more non-transitory computer-readable media storing computer-executable instructions that, when executed by one or more processors of a network element, cause a flow controller of the network element to perform operations comprising:
receiving a data packet for a user equipment (UE);
determining one or more packet characteristics of the data packet;
selecting, from a set of Quality of Experience (QoE) goals, a QoE goal that corresponds to the one or more packet characteristics;
determining a routing scheme that corresponds to the QoE goal based at least in part on telemetry data received from the UE; and
causing the data packet to be routed to the UE over at least one of a Long-Term Evolution (LTE) connection and a fifth generation (5G) connection based on the routing scheme.

18. The one or more non-transitory computer-readable media of claim 17, wherein the network element is a base station of a telecommunication network that is associated with one of the LTE connection or the 5G connection.

19. The one or more non-transitory computer-readable media of claim 17, wherein the network element is positioned between a core network of a telecommunication network and one or more base stations associated with the LTE connection or the 5G connection.

20. The one or more non-transitory computer-readable media of claim 17, wherein the set of QoE goals includes two or more of:
prioritizing throughput;
prioritizing lower latency; and
prioritizing reliability.
